(19) United States
(12) Patent Application Publication
(10) Pub. No.: US 2025/0392040 A1
(43) Pub. Date: Dec. 25, 2025

(54) FULL HEMISPHERE MILLIMETER COVERAGE USING EFFICIENT MODULE PLACEMENT

(71) Applicant: Reliance Communications, LLC, Hauppauge, NY (US)

(72) Inventors: Parveen Narula, Sands Point, NY (US); Venkat Kalkunte, Saratoga, CA (US)

(21) Appl. No.: 18/748,684

(22) Filed: Jun. 20, 2024

(51) Int. Cl. H01Q 3/02

(52) U.S. Cl. CPC H01Q 3/02

(57) ABSTRACT

An electronic device includes an upper portion, a lower portion and a back surface extending between the upper portion and the lower portion. Wireless communication circuitry within the electronic device has an antenna module. The antenna module is disposed in the upper portion and has an acute tilt relative to the back surface.

### BACKGROUND

The present invention generally relates to mobile user equipment, and more particularly to user equipment with a reduction in millimeter wave antennae for radio wave distribution.

Efficient propagation of millimeter wave signals determines performance of radio devices. Due to the randomness of mobile wireless channels, antenna systems in mobile user equipment (UE) need to provide large spherical coverage, which raises new challenges for the performance characterization of 5G mmWave UE. In the latest specification of the Third-Generation Partnership Project (3GPP), the requirement on UE’s spherical coverage in mmWave frequencies is defined, which is evaluated with a cumulative distribution function (CDF) of effective isotropic radiated power (EIRP).

Antenna systems in mobile UE need to be able to offer a large scanning angle to steer a beam towards to an optimal transmitting-receiving angle in a randomly changed mobile channel. A range of solid angles that UE can cover is known as the spherical coverage. Ideally, antenna systems in a mobile handset preferably have isotropic spherical coverage. Conventionally, network operators set minimum specifications for over-the-air (OTA) performance of UEs at sub-6 GHz cellular bands, which includes total radiated power (TRP) and total isotropic sensitivity (TIS). However, TRP and TIS are not suitable to characterize the beam steering capability of a UE. Parameters that can measure the power radiated towards a specific direction are needed to characterize the spherical coverage of a UE.

### SUMMARY

In accordance with an embodiment of the present invention, an electronic device includes an upper portion, a lower portion and a back surface extending between the upper portion and the lower portion. Wireless communication circuitry within the electronic device has at least one antenna module. The at least one antenna module is disposed in the upper portion and has an acute tilt relative to the back surface.

In accordance with another embodiment of the present invention, an electronic device includes an upper portion and a lower portion. The upper portion includes a left peripheral side and a right peripheral side. A back surface extends between the upper portion and the lower portion, and the back surface is opposite a front surface. Wireless communication circuitry within the electronic device has at least one antenna module that has a longitudinal axis along a length of the at least one antenna module and a width orthogonal to the length of the at least one antenna module. The at least one antenna module is disposed in the upper portion and has an acute tilt of the length relative to the back surface.

In accordance with another embodiment of the present invention, an electronic device includes an upper portion and a lower portion, the upper portion including a left peripheral side and a right peripheral side. A back surface extends between the upper portion and the lower portion, the back surface being opposite a display surface. Wireless communication circuitry within the electronic device has an antenna module. A tilt platform imparts an acute tilt to antenna module. The antenna module has a longitudinal axis along a length of the antenna module and a width orthogonal to the length of the antenna module. The antenna module is disposed in the upper portion and has an acute tilt of the length relative to the back surface.

In other embodiments, the acute tilt can include an angle of 30 degrees (positive or negative) or an angle of 10 degrees (positive or negative). The acute tilt can include a tolerance of ± 2 degrees. The at least one antenna module can be located in proximity to a first peripheral side of the electronic device and can include a single antenna module without needing an antenna module at a second peripheral side opposite the first peripheral side. The at least one antenna module can be positioned by a tilt platform that imparts the acute tilt to the at least one antenna module. The at least one antenna module can include a single antenna module between the left peripheral side and the right peripheral side. The at least one antenna module can be positioned by a tilt platform that imparts the acute tilt to the at least one antenna module. The tilt platform can include a surface that reflects radio waves.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a perspective view showing an upper portion of an electronic device with a phantom image of an antenna module having an acute tilt, in accordance with an embodiment of the present invention;

FIG. 2 is a perspective view showing an upper portion of an electronic device with a phantom image of an antenna module having an acute tilt along a top of the electronic device, in accordance with an embodiment of the present invention;

FIG. 3 is a cross-sectional view taken at section line B-B in FIG. 1 showing the upper portion of the electronic device with an antenna module having an acute tilt, in accordance with an embodiment of the present invention;

FIG. 4 is a cross-sectional view taken at section line B-B in FIG. 1 showing the upper portion with an antenna module having an acute tilt opposite to that of FIG. 2, in accordance with an embodiment of the present invention;

FIG. 5 is a partial cross-sectional view taken at section line C-C in FIG. 2 showing an antenna module having an acute tilt away from the top, in accordance with an embodiment of the present invention;

FIG. 6 is a partial cross-sectional view taken at section line C-C in FIG. 2 showing an antenna module having an acute tilt toward the top, in accordance with an embodiment of the present invention;

FIG. 7 is a side view of an antenna module having an acute tilt, in accordance with an embodiment of the present invention;

FIG. 8 is a rear view of the antenna module of FIG. 7 having the acute tilt, in accordance with an embodiment of the present invention;

FIG. 9 is a partial plan internal view of the electronic device showing a peripheral region with the antenna module having an acute tilt, in accordance with an embodiment of the present invention;

FIG. 10 is a partial plan view of the electronic device showing a polycarbonate over molding, in accordance with an embodiment of the present invention;

FIG. 11 is a partial side view of the electronic device showing a magnesium alloy midframe, in accordance with an embodiment of the present invention;

FIG. 12 shows antenna module positions, in accordance with an embodiment of the present invention;

FIG. 13 is a perspective view showing an isotropic radiation pattern in accordance with a finite element analysis for an acute tilt of positive 30 degrees, in accordance with an embodiment of the present invention;

FIG. 14 is a perspective view showing another isotropic radiation pattern in accordance with a finite element analysis for an acute tilt of negative 30 degrees, in accordance with an embodiment of the present invention; and

FIG. 15 is a block diagram showing an electronic device, in accordance with an embodiment of the present invention.

### DETAILED DESCRIPTION

In accordance with embodiments of the present invention, user equipment (UE) is provided that can meet spherical coverage requirements by configuring positions of antenna modules within the UE. Since the propagation of millimeter wave signals determines performance, the present embodiments achieve high performance with a single antenna module, that would normally require the use of at least two antenna modules. Due to the randomness of mobile wireless channels, antenna systems in mobile UE (e.g., 5G mmWave UEs) need large spherical coverage. The Third-Generation Partnership Project (3GPP) specification sets forth a requirement on UE’s spherical coverage in mmWave frequencies, which is evaluated with a cumulative distribution function of the effective isotropic radiated power (EIRP).

Hemisphere requirements enforce a minimum amount of symmetry in spherical coverage. Left, right and front hemispheres include separate requirements in free space. Between the left and right hemispheres, one hemisphere shall contain greater than or equal to 35% of the total number of angles within a complete sphere that are greater than or equal to the minimum 50 percentile limit for a given channel under test, while the other hemisphere shall contain greater than or equal to 30% of the total number of angles within the complete sphere that are greater than or equal to the 50 percentile limit for the given channel under test. The front hemisphere shall contain greater than 25 percent of the total number of angles within the complete sphere that are greater than or equal to the minimum 50 percentile limit for the given channel under test. In exemplary instances, the specified EIRP can be 19.1 dBm-TT for a first design and 20.9 dBm-TT (TT is test tolerance) for a second design. The 50 percentile than becomes 19.1 – 1.5 = 17.6 dBm-TT for the first design and 20.9 – 1.5 = 19.4 dBm-TT for the second design.

In accordance with embodiments or the present invention, the hemisphere requirement for a UE device can be met by providing location and placement of an antenna module to achieve the EIRP and effective isotropic sensitivity (EIS) targets established by a mobile operator. In an embodiment, an antenna module is placed in an upper region of the device and maintained at a nonzero acute angle relative to a back surface of the UE device. In a particularly useful embodiment, the acute angle or acute tilt includes a 30 degree angle. For example, the 30 degree angle can be a +30 degrees or –30 degrees. In another embodiment, the acute angle or acute tilt includes a 10 degree angle. For example, the 10 degree angle can be a +10 degrees or –10 degrees. By placing an antenna module at an angle, the number of antenna modules can be reduced while still maintaining or exceeding EIRP and EIS specifications to provide spherical coverage. In addition, fewer antenna modules results is less power consumption and reduced equipment costs. In one embodiment, a single antenna module is employed for the entire UE device.

Antenna systems in a mobile handset preferably have isotropic spherical coverage. By employing materials, such as absorber foams, polycarbonate shields, and combining them with a custom beam book, a high performance system that passes all mobile operator tests is achieved. These material properties along with airgaps result in optimal coverage. Embodiments of the present invention are applicable to mobile hotspots, millimeter wave phones, customer premises equipment (CPE) and any other useful mobile radio equipment.

A beam book or codebook is a set of phase values and its representation in a spatial domain. It is a file stored in memory that contains numbers for solid angles, e.g., at 5 degree steps. In addition to placement and orientation of an antenna module the bean book assists in ensuring the hemispherical coverage. The orientation and placement combine with the beam book to provide a set of directives for hardware to use weighted scalars to apply to each solid angle. So that the orientation employed with the beam book creates desired radiation patterns in accordance with embodiments of the present invention.

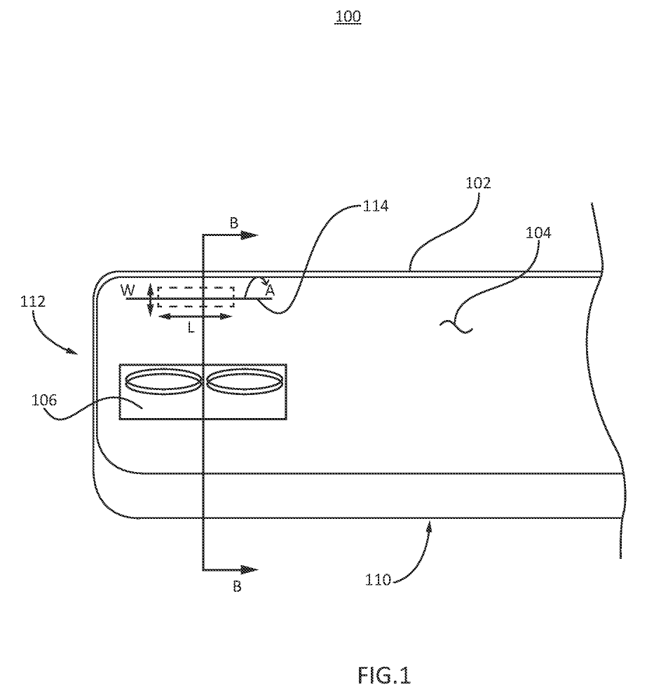

Referring now to the drawings in which like-numerals represent the same or similar elements and initially to FIG. 1, a perspective view of an electronic device 100 is shown in accordance with an embodiment of the present invention. The electronic device 100 includes wireless circuitry. The wireless circuitry can include one or more antennas. The antennas may include phased antenna arrays employed in millimeter wave communications, which can include signals with frequencies between about 10 GHz and 400 GHz. The electronic device 100 can be employed for any type of wireless communication including, e.g., satellite navigation systems, cellular telephone signals, near-field communications, local wireless area network signals or other wireless communications.

The electronic device 100 may be a computing device such as a computer, a laptop, a tablet computer, a cell phone, a hotspot, a smart watch device, a pendant device, a headphone or earpiece device, a device embedded in eyeglasses or other wearable equipment, a gaming device, a navigation device or other electronic equipment. In the illustrative embodiment of FIG. 1, the electronic device 100 is a portable device such as a cell phone. Other configurations may be used for the electronic device 100.

Antennas may be mounted in a housing 102 of the electronic device 100. To avoid disrupting communications when an external object such as a human hand or other body part of a user blocks one or more antennas, antennas may be mounted at multiple locations in housing 102. Sensor data such as proximity sensor data, real-time antenna impedance measurements, signal quality measurements such as received signal strength information, and other data may be used in determining when an antenna (or set of antennas) is being adversely affected due to the orientation of housing 102, blockage by a user's hand or other external object, or other environmental factors. The electronic device 100 can then switch an antenna (or set of antennas) into use in place of the antennas that are being adversely affected.

Antennas (not shown) can be mounted along peripheral edges of housing 102, on a back or rear portion 104 of the housing 102, under display cover glass provided opposite the rear portion on a front portion 110 of the electronic device 100 or elsewhere within the electronic device 100.

Antennas can be provided as phased arrays in an antenna module(s) 108. The antenna module(s) 108 can include mmWave 5G modules from any number of commercially available antenna modules, such as e.g., QTM525, QTM535, QTM565, QTM567, etc. available from Qualcomm®. Other antenna modules from other manufacturers can also be employed. In an embodiment, the antenna module 108 includes radiation elements in a linear array or rectangular array pattern. In a particularly useful embodiment, the antenna module 108 can include as few as four radiation elements and still achieve the EIRP criteria. In other embodiment, greater numbers of radiating elements can be employed.

In an embodiment, a single antenna module 108 can be placed in an upper portion 112 of the electronic device 100. The antenna module 108 is depicted in dashed lines as the antenna module 108 is located within the housing 102. The antenna module 108 includes an acute tilt indicated by angle A relative to a plane of the rear portion 104 of the electronic device 100. The acute tilt can include an angle of about +30 degrees relative to a plane of the rear portion 104. In particularly useful embodiments, the 30 degree tilt is precisely held with a ±2 degrees and more particularly ±1 degree. The acute tilt is side facing, meaning tilted away from a peripheral side of the upper portion 112 of the electronic device 100. Said differently, a length axis 114 of the antenna module 108 is rotated in a plane perpendicular to the rear portion 104 by a positive 30 degree angle from vertical. The antenna module 108 includes a width side W. In other embodiments, the acute tilt can face in other directions relative to the electronic device 100. For example, in another embodiment, the acute tilt can include an angle of about +10 degrees relative to a plane of the rear portion 104. The 10 degree tilt is precisely held with a ±2 degrees and more particularly ±1 degree. The acute tilt is side facing, meaning tilted away from a peripheral side of the upper portion 112 of the electronic device 100.

The antenna module 108 can include a plurality of radiating elements that combine to provide a desired radiation pattern, which can be implemented using a codebook or beam book. The number of radiation elements can vary depending on a chip set and design of the antenna module 108.

The antenna module 108 is located in the upper portion and can be located on a left side or a right side of the electronic device 100. The left or right side should be selected in accordance with the type and density of metal components, selecting the side with fewer and less dense metal components. In an example, the antenna module 108 can be located on lateral side opposite a camera module 106 and on or at a periphery of the of the electronic device 100. In this way, less metal structure is present. It should be understood that the placement of the antenna module 108 can be on the right or the left side of the electronic device 100, as described.

In another embodiment, the antenna module 108 is placed in the upper portion 112 of the electronic device 100 and includes an acute tilt of the angle A of about negative 30 degrees relative to a plane of the rear portion 104. In particularly useful embodiments, the negative 30 degree tilt is precisely held with a ±2 degrees and more particularly ±1 degree. The axis 114 of the antenna module 108 is rotated in a plane perpendicular to the rear portion 104 by a negative 30 degree angle from vertical. In other embodiments, the acute tilt can include other angles.

In another embodiment, the antenna module 108 includes an acute tilt of the angle A of about negative 10 degrees relative to a plane of the rear portion 104. In particularly useful embodiments, the negative 10 degree tilt is precisely held with a ±2 degrees and more particularly ±1 degree.

The antenna module 108 is located in the upper portion 112 and can be located on a left side or a right side of the electronic device 100. The left or right side should be selected in accordance with the type and density of metal components, selecting the side with fewer and less dense metal components. It should be understood that the placement of the antenna module 108 can be on the right or the left side of the electronic device 100, as described.

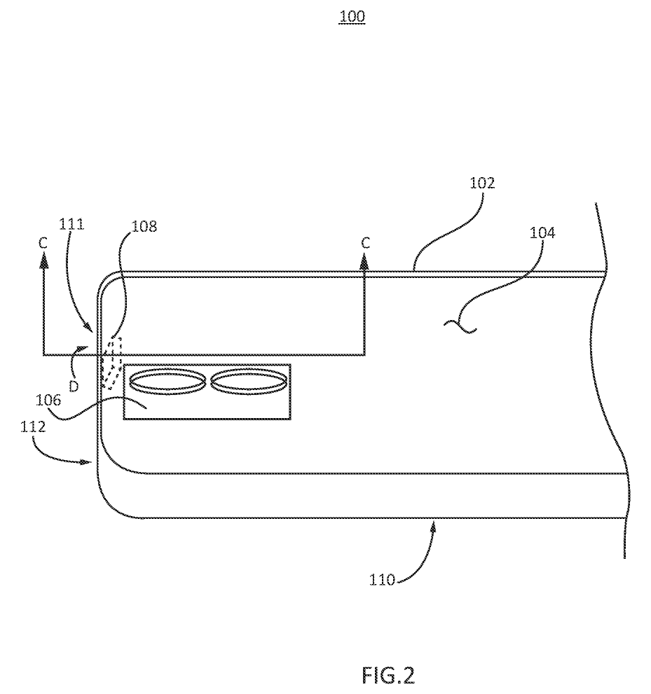

Referring to FIG. 2, in another embodiment, the antenna module 108 can be placed in an upper portion 112 of the electronic device 100 along a top 111 of the electronic device 100. The antenna module 108 is depicted in dashed lines as the antenna module 108 is located within the housing 102. The antenna module 108 includes an acute tilt indicated by angle D relative to a plane of the rear portion 104 of the electronic device 100. The acute tilt can include an angle of about +30 degrees relative to a plane of the rear portion 104. In particularly useful embodiments, the 30 degree tilt is precisely held with a ±2 degrees and more particularly ±1 degree. The acute tilt is front facing, meaning tilted with respect to the top 111 of the upper portion 112 of the electronic device 100. In other embodiments, the acute tilt can face in other directions relative to the electronic device 100. For example, in another embodiment, the acute tilt can include an angle of about +10 degrees relative to a plane of the rear portion 104. The 10 degree tilt is precisely held with a ±2 degrees and more particularly ±1 degree.

In another embodiment, the antenna module 108 includes an acute tilt of the angle D of about negative 30 degrees relative to a plane of the rear portion 104. In particularly useful embodiments, the negative 30 degree tilt is precisely held with a ±2 degrees and more particularly ±1 degree. In yet another embodiment, the antenna module 108 can include an acute tilt of the angle D of about negative 10 degrees relative to a plane of the rear portion 104. In particularly useful embodiments, the negative 10 degree tilt is precisely held with a ±2 degrees and more particularly ±1 degree. The antenna module 108 can be located (instead of the top 111 or in addition to the top 111) at a bottom (opposite the top) of the electronic device 100.

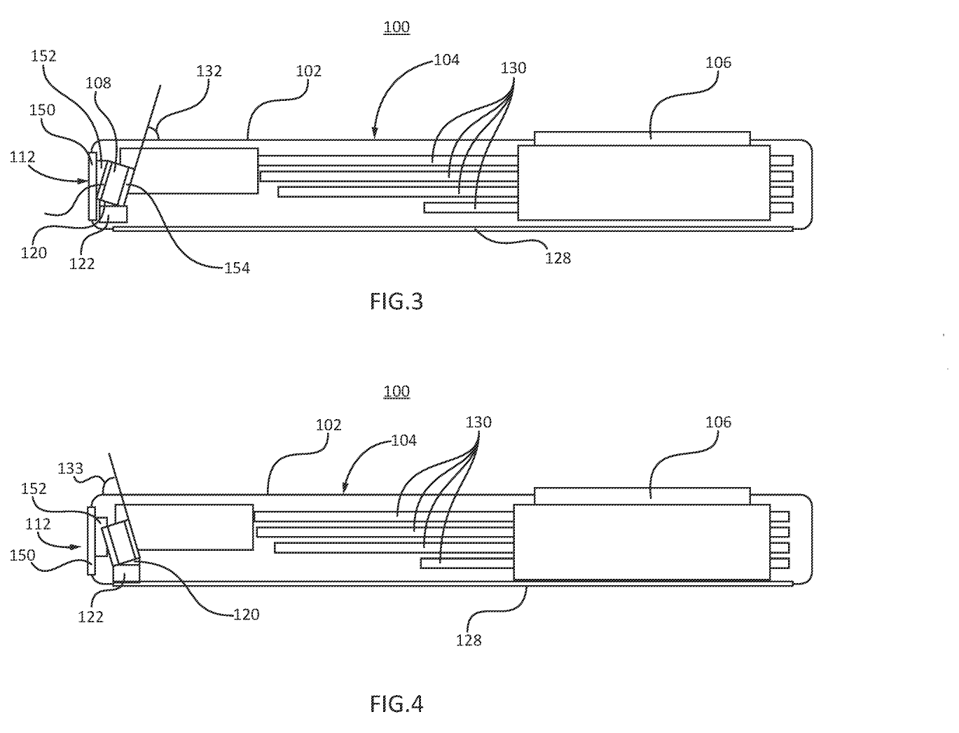

Referring to FIG. 3, a cross-sectional view of internal components of the electronic device 100 taken at section line B-B in FIG. 1 is shown in accordance with embodiments of the present invention. The antenna module 108 is depicted as being tilted at an acute angle 132 (angle A, FIG. 1). A tilt platform 120 is included within the electronic device 100 to support and mount the antenna module 108 at the acute angle 132.

In one embodiment, the tilt platform 120 can be employed to assist in the fabrication of the electronic device 100 to provide a platform to mount the antenna module 108 at the desired orientation. The tilt platform 120 can include a sleeve or other supporting structure to permit the antenna module 108 to be supported on one or more surfaces during fabrication and during operation. The tilt platform 120 can include a polymeric material. In one embodiment, the tilt platform 120 can be coated or include a material that reflects radio waves, e.g., a metal foil or paint. For example, a mirrored surface of on the tilt platform 120 can include aluminum or copper foil. In other embodiments, the tilt platform 120 can include a material transparent to radio waves. A thermal pad (not shown) can be disposed between the tilt platform 120 and the antenna module 108.

The tilt platform 120 can include mounting features for receiving and angling the antenna module 108 at the acute angle 132. The tilt platform 120 can be precisely fabricated to hold the desired acute angle 132 within the desired tolerances to ensure hemispherical parameters are met. The tilt platform 120 and the antenna module 108 can comprise a sub-assembly that can be mounted directly to a chassis or frame of the housing 102 of the electronic device 100. A mounting fixture 122 can be employed to secure the tilt platform 120, the antenna module 108 and/or the subassembly formed by these components. The tilt platform 120 can be incorporated within other features or components of the electronic device 100. For example, the tilt platform 120 or the mounting fixture 122 can include angled metal terminals that can connect to a printed wiring board of the electronic device 100 and the acute angle 132 can be maintained by the angled metal terminals.

The electronic device 100 may include a display such as display 128. Display 128 may be mounted in the housing 102. The housing 102 can be formed of plastic, glass, ceramics, composites, metal (e.g., stainless steel, aluminum, etc.), other suitable materials, or a combination of any two or more of these or other materials. The housing 102 can be machined or molded as a single structure or may be formed using multiple structures (e.g., one or more structures that form exterior housing surfaces, etc.). The housing 102 encapsulates and protects internal components of the electronic device 100. The internal components can include one or more printed wiring boards 130. The printed wiring boards 130 can include circuitry as well as support components such as, e.g., a speaker, a microphone, memory, a processor, camera module 106, display 128, a battery, antennas, transmitters, receivers, antenna modules, etc.

The display 128 can be touch-sensitive or not touch sensitive. A touch screen display can incorporate a layer of conductive capacitive touch sensor electrodes or other touch sensor components. The display 128 may include an array of display pixels based on any display technology. The display 128 includes a layer of transparent glass, clear plastic or other transparent dielectric.

Referring to FIG. 4, a cross-sectional view of internal components of the electronic device 100 taken at section line B-B in FIG. 1 is shown in accordance with another embodiment of the present invention. The antenna module 108 is depicted as being tilted at an acute angle 133 (angle A, FIG. 1). The tilt platform 120 of FIG. 3 is reversed from that of FIG. 3. The tilt platform 120 is included within the electronic device 100 to support and mount the antenna module 108 at the acute angle 133.

In one embodiment, the tilt platform 120 can be employed to assist in the fabrication of the electronic device 100 to provide a platform to mount the antenna module 108 at the desired orientation. The tilt platform 120 can include a sleeve or other supporting structures to permit the antenna module 108 to be supported during fabrication and during operation. The tilt platform 120 can include a polymeric material. The tilt platform 120 can be configured to reflect, absorb or transmit radio waves, as needed.

The tilt platform 120 can include mounting features for receiving and angling the antenna module 108 at the acute angle 133. The tilt platform 120 can be precisely fabricated to hold the desired acute angle 133 within the desired tolerances to ensure hemispherical parameters are met. The tilt platform 120 can be mounted directly to a chassis or frame of the housing 102 of the electronic device 100, or the tilt platform 120 can be mounted on a mounting fixture 122. The mounting fixture 122 can then be employed to secure the tilt platform 120 and can be customized to fit the available space.

The tilt platform 120 can be incorporated within other features or components of the electronic device 100. For example, the tilt platform 120 or the mounting fixture 122 can include angled metal terminals that can connect to a printed wiring board of the electronic device 100 and the acute angle 133 can be maintained by the angled metal terminals.

Referring to FIG. 5, a cross-sectional view of internal components of the electronic device 100 taken at section line C-C in FIG. 2 is shown in accordance with embodiments of the present invention. The antenna module 108 is depicted as being tilted at an acute angle 162 (angle D, FIG. 2) at the top 111 (or bottom) of the electronic device 100. A tilt platform 121 is included within the electronic device 100 to support and mount the antenna module 108 at the acute angle 162.

In one embodiment, the tilt platform 121 can be employed to assist in the fabrication of the electronic device 100 to provide a platform to mount the antenna module 108 at the desired orientation. The tilt platform 121 can include a sleeve or other supporting structure to permit the antenna module 108 to be supported on one or more surfaces during fabrication and during operation. The tilt platform 121 can include a polymeric material. In one embodiment, the tilt platform 121 can be coated or include a material that reflects radio waves, e.g., a metal foil or paint. For example, a mirrored surface of on the tilt platform 121 can include aluminum or copper foil. In other embodiments, the tilt platform 121 can include a material transparent to radio waves. A thermal pad (not shown) can be disposed between the tilt platform 121 and the antenna module 108.

The tilt platform 121 can include mounting features for receiving and angling the antenna module 108 at the acute angle 162. The tilt platform 120 can be precisely fabricated to hold the desired acute angle 162 within the desired tolerances to ensure hemispherical parameters are met. The tilt platform 120 and the antenna module 108 can comprise a sub-assembly that can be mounted directly to a chassis or frame of the housing 102 of the electronic device 100. A mounting fixture 122 can be employed to secure the tilt platform 121, the antenna module 108 and/or the subassembly formed by these components. The tilt platform 121 can be incorporated within other features or components of the electronic device 100. For example, the tilt platform 121 or the mounting fixture 122 can include angled metal terminals that can connect to a printed wiring board of the electronic device 100 and the acute angle 162 can be maintained by the angled metal terminals.

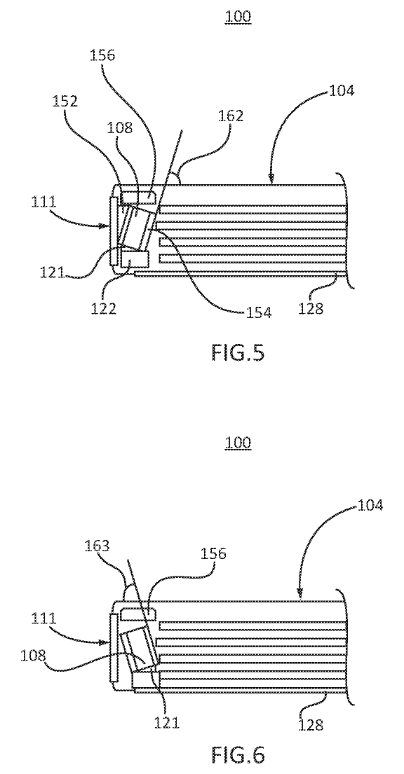

Referring to FIG. 6, a cross-sectional view of internal components of the electronic device 100 taken at section line C-C in FIG. 2 is shown in accordance with another embodiment of the present invention. The antenna module 108 is depicted as being tilted at an acute angle 163 (angle D, FIG. 2). The tilt platform 121 of FIG. 6 is reversed from that of FIG. 5. The tilt platform 121 is included within the electronic device 100 to support and mount the antenna module 108 at the acute angle 163.

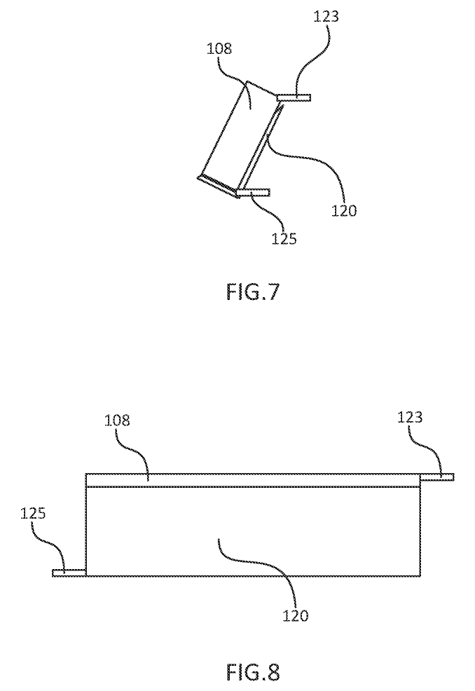

Referring to FIG. 7, a side view of the antenna module 108 in the tilt platform 120 (or tilt platform 121) where the tilt platform 120 (or the mounting fixture 122, not shown) includes angled metal terminals 123, 125 that can connect to a printed wiring board (130FIG. 3, FIG. 4) of the electronic device 100. The angled metal terminals 123, 125 are illustratively shown in a configuration at end portions on the antenna module 108. However, the angled metal terminals 123, 125 can connect through the tilt platform 120 or connect directly to the angled metal terminals 123, 125. The acute angle 132 or angle 133 can be maintained by the angled metal terminals 123, 125 and/or the tilt platform 120. It should be noted that in some embodiments, the terminals 123, 125 can be provided in a same plane, e.g., both at the top, or both at the bottom, etc., as needed.

Referring to FIG. 8, a rear view of the antenna module 108 in the tilt platform 120 (or tilt platform 121) is illustratively shown. The tilt platform 120 or the mounting fixture 122 can include the angled metal terminals 123, 125 that can connect to a printed wiring board (130 FIG. 3, FIG. 4) of the electronic device 100 is shown.

It should be understood that the tilt platform 120 can support more than one side of the antenna module 108. For example, the tilt platform 120 can include portions that support one or two length (L) sides of the antenna module 108, one or two width (W) sides of the antenna module 108, a top and/or bottom of the antenna module 108 or any combination of these features.

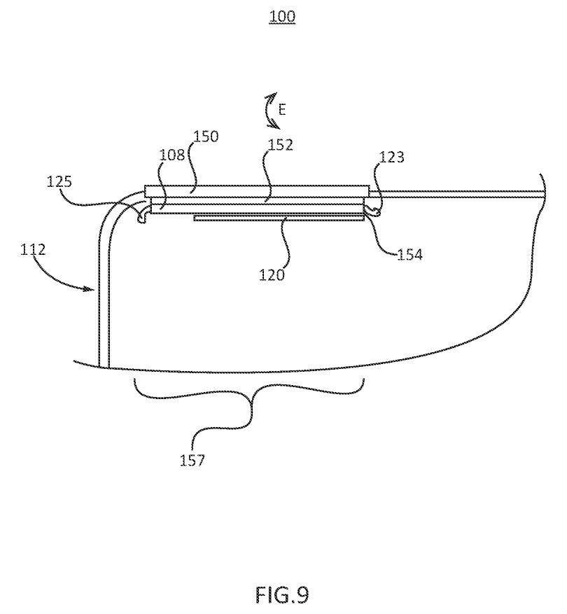

Referring to FIG. 9, a partial plan view of the electronic device 100 shows an internal region at a periphery of the electronic device 100. The antenna module 108 includes an acute tilt in the direction of arrow E. The antenna module 108 is supported by the tilt platform 120. The tilt platform 120 can integrate an enclosing bracket that supports the antenna module 108. A thermal pad 154 (e.g., acrylic foam) can be disposed between the antenna module 108 and the tilt platform 120. An air space or aerogel layer 152 can be provided on the antenna module 108. The aerogel layer 152 can be configured to assist in the disbursement of radio waves. A cover 150 fits into the housing 102 to cover the antenna module 108. The cover 150 includes a dielectric antenna window formed within an opening, e.g., in the housing 102. The cover 150 can include a polycarbonate material, such as a glass fiber polycarbonate (e.g., 20% glass fiber), a high density polyethylene or other plastic material that permits transmission and disbursement of radio waves. The antenna module 108 is electrically connected to internal printed wiring boards through metal terminals 123 and 125.

A region 157 includes material conducive to the distribution of radio waves. The materials selected for the electronic device 100 within the region 156 can include features that assist in disbursing radio waves to provide a uniform hemispherical distribution.

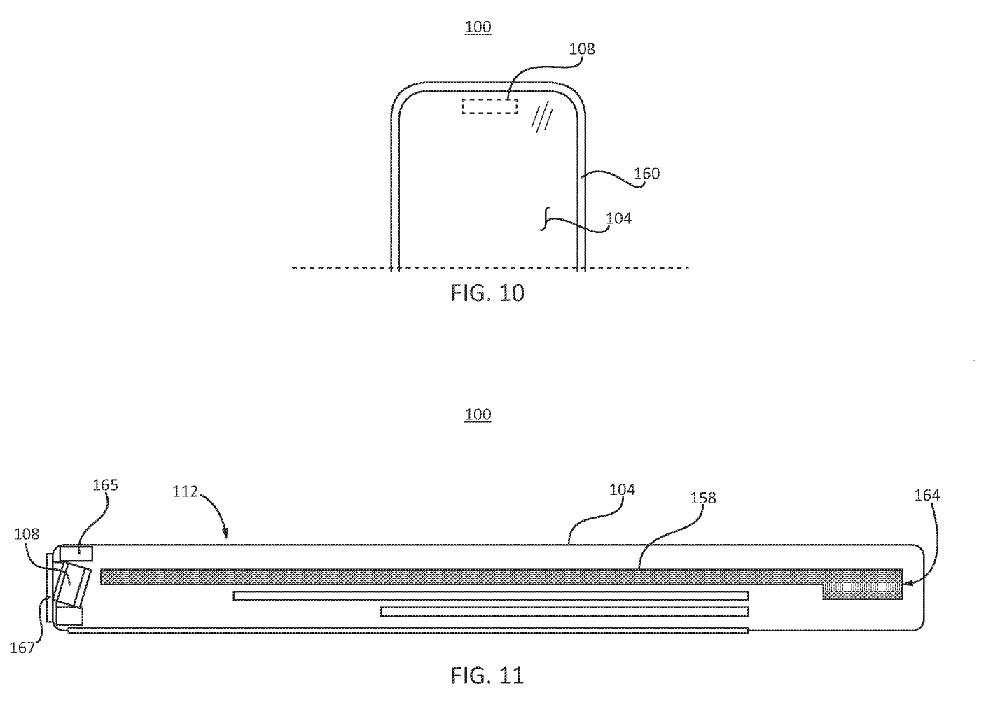

Referring now to FIGS. 10 and 11, to improve disbursement of radio waves and to permit isotropic radiation patterns, the rear portion 104 (back cover) includes a material selected to disburse radio waves. In one example, the rear portion 104 can include a polycarbonate material. The polycarbonate material can include a disbursing media, such as glass or other materials. The permittivity of the polycarbonate rear portion 104 has a bearing on the diffraction of the radio waves. In addition to the rear portion 104, surrounding material properties of a magnesium alloy frame 158 for the housing structure at least in a midframe region 164, a polycarbonate ring 160 encircling the electronic device within the midframe region 164 have a bearing on the cumulative distribution function (CDF) for 20%, 50%, 100% EIRP.

The peak EIRP value of an antenna array can be affected by multiple factors, e.g., number of elements, output power from a power amplifier, implementation loss when the antenna is integrated into a device, etc. A cumulative distribution function (CDF) of the EIRP of the electronic device 100 can be calculated through equation (EQ. 1), where the right-hand side of the equation represents the probability that the measured EIRP(θ , φ ) of the electronic device 100 takes on a value less than or equal to a threshold EIRP value. The electronic device 100 (device under test = dut) needs to generate a transmitted beam and needs to support a beam-lock mode that can retain the beam during each measurement period.

CDF(EIRP) = P(EIRPdut(θ,φ) ≤ EIRP) EQ. 1

where EIRP is the measurement criteria of power in a specific direction, including the transmitted power, the transmission loss in a radiofrequency (RF) chain, implementation loss, the array gain.

The magnesium alloy frame 158 provides structural elements that are strong and durable. The magnesium alloy frame 158 is also good at dissipating heat and dampening vibrations and shock. With a low impact on the transmission of radio waves, the magnesium alloy frame 158 has favorable mechanical properties and a lower melting point.

The magnesium alloy frame 158 can include an over molded plastic, e.g., polycarbonate ring 160, to form the structure of the midframe region 164. The rear portion 104 (back cover) can also include polycarbonate. Polycarbonate features stack to produce improved properties to assist in the distribution of RF. A front casing 167 and a support 165 can also include RF transmissive and dispersive materials. The front casing 167 and support 165 can include, e.g., polycarbonate material with 10- 40% glass fiber.

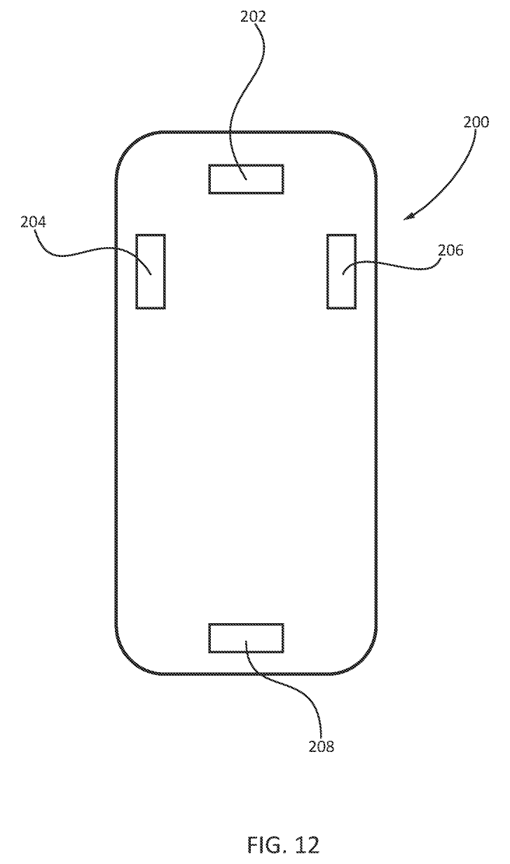

Referring to FIG. 12, a schematic diagram of user equipment 200 (UE) is shown in accordance with an illustrative embodiment. The UE 200 can include a cell phone, a mobile hot spot or any other wireless device. The UE 200 shows positions 202, 204, 206 and 208 where antenna modules 108 can be located. The antenna modules 108 can cooperate with a plurality of antennas (not shown) distributed within the UE 200 or can function alone. In accordance with an embodiment, by orienting the antenna module 108 at position 204 in accordance with the acute tilt, the antenna module 108 at position 206 can be eliminated (or vice versa). Likewise, by orienting the antenna module 108 at position 208 in accordance with the acute tilt, the antenna module 108 at position 208 can be eliminated ( or vice versa).

Using high-frequency structure simulation (HFSS), a single antenna module 108 placed and angled in accordance with the present embodiments meets at least 50 percentile EIRP performance targets, and marginal 20 percentile EIRP performance targets. In this way, at least one antenna module 108 can be eliminated from the UE 200.

A coverage efficiency and a total scan pattern are defined to measure spherical coverage of a beam steering antenna system where the total scan pattern can be obtained from all possible beam steering radiation patterns by extracting the best achievable gain at every solid angular point. The total covered solid angles of the antenna system can be retrieved from its total scan pattern with respect to a threshold gain value which is sufficient to support a link budget of the wireless communication. Then, the spherical coverage can be quantified by the coverage efficiency which is defined as the ratio between the total covered solid angles and a whole surrounding sphere. The EIRP is a function of number antenna elements.

In accordance with embodiments of the present invention, employing a single antenna module 108 (e.g., at position 204) having a mechanical tilt of about 30 degrees and eliminating a second antenna module (e.g., from position 206) provides EIRP coverage performance that exceeds acceptable performance specifications. In accordance with another embodiment, another antenna module 108 (e.g., at position 208) having a mechanical tilt of about 30 degrees and eliminating a second antenna module (e.g., from position 202) can be employed together with the antenna module 108 (e.g., at position 204) to provide even better EIRP coverage performance.

It should be understood that antenna modules 108 can be located at other positions instead of or in addition to the one or more positions 202, 204, 206 and 208 indicated in FIG. 12. For example, one antenna module 108 can be located at position 204 and another at position 208, or one antenna module 108 can be located at position 206 and another at position 208 or one antenna module 108 can be located at position 202 and another at a different position on the device, etc.

In an example of performance in a 27.5 - 28.35 GHz device with a single QTM535 antenna module located at a side housing position and having an acute tilt of 30 degrees, the 20% EIRP was 18.6 dBm which exceeded the specification of 15 dBm. For the same 27.5 - 28.35 GHz device employing the single QTM535 antenna module located at a side housing position and having an acute tilt of 30 degrees, the 50% EIRP was 22.4 dBm which exceeded the specification of 19.9 dBm. For the same 27.5 - 28.35 GHz device with the single QTM535 antenna module located at a side housing position and having an acute tilt of 30 degrees, the 100% EIRP was 30.1 dBm which exceeded the specification of 30.8 dBm.

In another example, in a 37 - 40 GHz device with a single QTM535 antenna module located at a side housing position and having an acute tilt of 30 degrees, the 20% EIRP was 15.9 dBm which exceeded the specification of 13.0 dBm. For the same 37 - 40 GHz device with the single QTM535 located at a side housing position and having an acute tilt of 30 degrees, the 50% EIRP was 21.0 dBm which exceeded the specification of 18.1 dBm. For the same 37- 40 GHz device with the single QTM535 located at a side housing position and having an acute tilt of 30 degrees, the 100% EIRP was 30.8 dBm which exceeded the specification of 25.1 dBm.

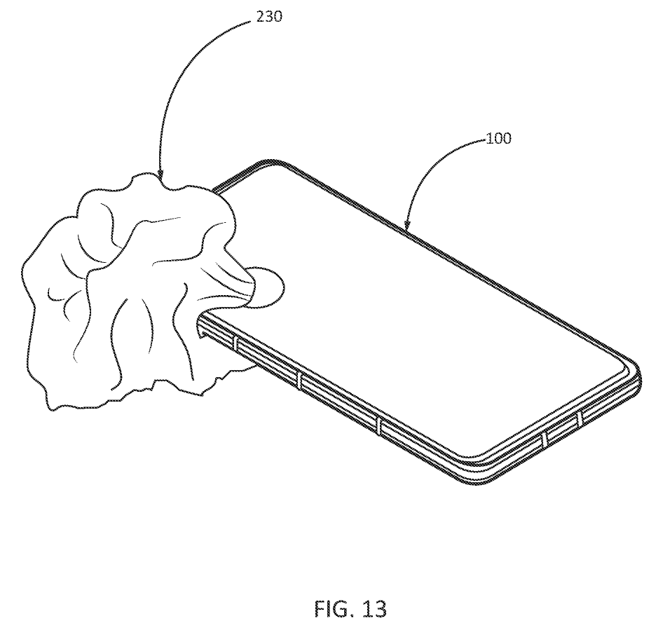

Referring to FIG. 13, an illustrative radiation pattern 230 for the electronic device 100 is shown in accordance with an HFSS finite element simulation in accordance with the present embodiments. The HFSS simulation shows the electronic device 100 (in this case a cell phone) having a high level of isotropic spherical coverage for the radiation pattern 230 from a single antenna module oriented at a positive 30 degree angle accordance with an embodiment. The single antenna module exceeds the 3GPP specification in terms of EIRP and EIS. For example, HFSS simulation supports that the single antenna module meets 50 percentile performance targets, marginal 20 percentile performance targets, etc.

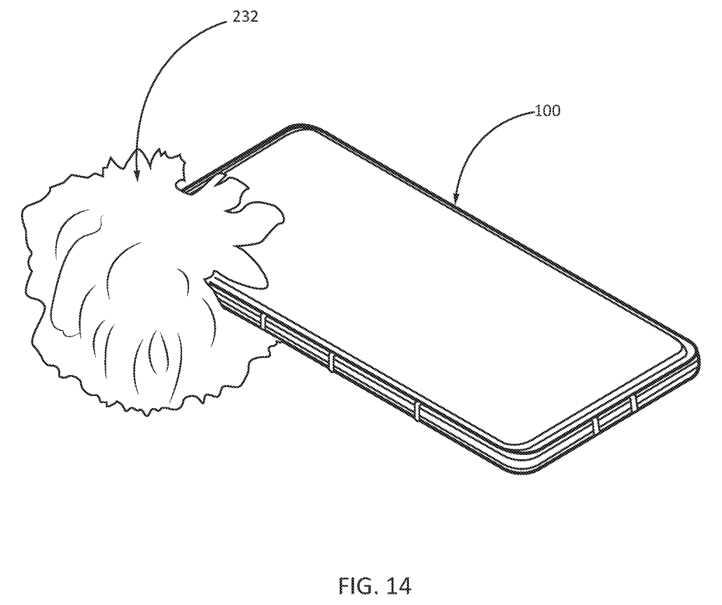

Referring to FIG. 14, an illustrative radiation pattern 232 for the electronic device 100 is shown in accordance with an HFSS finite element simulation in accordance with the present embodiments. The HFSS simulation shows the electronic device 100 (in this case a cell phone) having a high level of isotropic spherical coverage for the radiation pattern 232 from a single antenna module oriented at a negative 30 degree angle accordance with an embodiment. The single antenna module exceeds the 3GPP specification in terms of EIRP and EIS. For example, HFSS simulation supports that the single antenna module meets 50 percentile performance targets, marginal 20 percentile performance targets, etc.

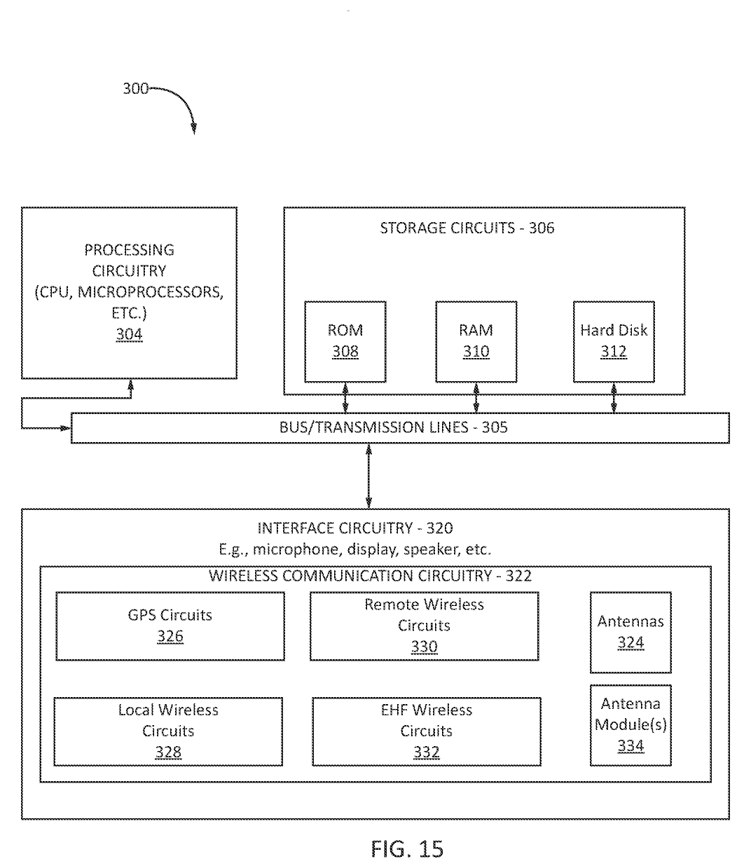

Referring to FIG. 15, an exemplary electronic device 300 to which the present invention may be applied is shown in accordance with an embodiment. The electronic device 300 can include the electronic device 100 as described herein. The electronic device 300 includes control circuitry or processing circuitry 304. The processing circuitry 304 can include one or more microprocessors, computer processing units (CPUs), microcontrollers, baseband processor integrated circuits, digital signal processors, application specific integrated circuits, etc. operatively coupled to other components via a system bus 305.

The processing circuitry 304 may be used to run software, such as, interface, communication and/or network protocols or applications, e.g., internet browsing applications, telephone call applications, email applications, sensor applications, media playback applications, operating system functions, voice-over-internet-protocol (VOIP), etc. To support interactions with external equipment, processing circuitry 304 may be used in implementing communications protocols.

Communications protocols can include internet protocols, wireless local area network protocols (e.g., IEEE 802.11 protocols), protocols for other short-range wireless communications links such as the Bluetooth® protocol, cellular telephone protocols, MIMO protocols, antenna diversity protocols, satellite navigation system protocols, etc.

Storage circuitry 306 or storage devices can include a plurality of different devices and memory storage elements (e.g., non-transitory storage). For example, the storage circuitry 306 can include a Read Only Memory (ROM) 308, a Random Access Memory (RAM) 310, hard disk drive storage 312, etc. operatively coupled to the system bus 305. Storage circuitry 306 can include any type of storage device, such as, e.g., disk storage (e.g., a magnetic or optical disk storage device), a solid state magnetic device, and so forth. The storage devices can be the same type of storage device or different types of storage devices. Storage circuitry 306 can store beam book files and other protocols for operating the electronic device 300.

Interface circuitry 320 includes input/output devices that permit interactions with the electronic device 300, e.g., data, sound, light, etc. and other communications between the electronic device 300, one or more users and a network or networks. Interface circuitry 320 permits data to be supplied to and from the electronic device 300 to external devices. Interface circuitry 320 may include user interface devices, data port devices, and other input-output components, for example, touch or non-touch screens, buttons, joysticks, scrolling wheels, touch pads, key pads, keyboards, microphones, cameras, speakers, status indicators, light sources, audio jacks and other audio port components, digital data port devices, light sensors, accelerometers or other sensor components, positioning sensors, capacitance sensors, proximity sensors (e.g., a capacitive proximity sensor and/or an infrared proximity sensor), magnetic sensors, a port/connector sensor and/or other sensors and components.

Interface circuitry 320 includes wireless communications circuitry 322 for communicating wirelessly with external equipment. Wireless communications circuitry 322 can include radiofrequency (RF) transceiver circuitry formed from one or more integrated circuits, power amplifier circuitry, low-noise input amplifiers, passive RF components, one or more antennas 324, transmission lines, and other circuitry for handling RF wireless signals.

Wireless communications circuitry 322 can include RF transceivers that handle different radio-frequency communications bands. In an embodiment, global positioning system (GPS) circuits 326 can include transceiver circuitry for transmitting and receiving GPS signals or other satellite positioning data. Local wireless circuits 328 can be employed for 2.4 GHz and 5 GHz bands for WiFi® (IEEE 802.11) communications and can handle the 2.4 GHz Bluetooth® communications band, among other bands and protocols. Remote wireless circuits 330 can be employed for cellular telephone communications for voice data and/or non-voice data in frequency ranges such as, e.g., a low communications band from 700 to 960 MHz, a midband from 1710 to 2170 MHz, and a high band from 2300 to 2700 MHz or other communications bands between 700 MHz and 2700 MHz or other suitable frequencies.

Extremely high frequency (EHF) wireless circuits 332 can convey signals can handle over line-of-sight path communications (e.g., millimeter wave communications). Antennas can include phased antenna arrays and beam steering techniques. Antenna diversity schemes may also be employed to ensure that the antennas that have become blocked or that are otherwise degraded due to the operating environment can be switched out of use and higher-performing antennas used in their place. EHF wireless circuits 332 can include millimeter wave transceiver circuitry that can support communications at extremely high frequencies (e.g., millimeter wave frequencies from 10 GHz to 400 GHz or other millimeter wave frequencies). In other embodiments, wireless communications circuitry 322 can include circuitry for receiving television and radio signals, near field communications (NFC) circuitry, etc.

Antennas 324 in wireless communications circuitry 322 can include any suitable antenna types. For example, antennas 324 may include resonating elements, loop antennas, patch antennas, inverted-F antennas, slot antennas, planar inverted-F antennas, helical antennas, hybrids of these designs and other designs, etc. Different types of antennas can be employed for different bands and combinations of bands.

Transmission lines shown generally as the system bus 305 route antenna signals within the electronic device 300. Filter circuitry, switching circuitry, impedance matching circuitry, and other circuitry can be included within the transmission lines, if desired.

The antenna 324 can include or be employed with one or more antenna modules 334. The antenna modules 334 can include antenna module 108 (FIG. 1, 2). Antenna adjustments may be made to tune antennas to perform in desired frequency ranges, to perform beam steering with a phased antenna array, and to otherwise optimize antenna performance. Sensors may be incorporated to gather sensor data in real time for adjusting the antenna modules 334 (and antennas 324). The antenna modules 334 can be employed in handling millimeter wave signals for EHF wireless circuits 332 and can be implemented as phased antenna arrays for use in beam steering to optimize wireless performance. In accordance with embodiments of the present invention, a single antenna module 334 can be employed to provide a same power and isotropic distribution of radiation that would require two or more antenna modules in conventual designs. By reducing a number of antenna modules 334, power is conserved, which can extend battery life and reduce costs of the electronic device 300.

It should be understood that embodiments of the present invention are applicable to any wireless device including but not limited to cell phones, hotspots, other mobile devices, e.g., in vehicles, tablets, laptops, etc. Although described with respect to 5G mmWave, the present embodiments are applicable to other generations of cellular technology, e.g., 3G, 4G, 5G and beyond and other frequency bands.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The block diagrams in the Figures illustrate the architecture, functionality, and operation of possible implementations of systems, methods, and computer program products according to various embodiments of the present invention. In this regard, each block in the diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of systems, devices and methods (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. An electronic device, comprising:
an upper portion and a lower portion;
a back surface extending between the upper portion and the lower portion;
wireless communication circuitry within the electronic device having at least one antenna module; and
the at least one antenna module being disposed in the upper portion and having an acute tilt relative to the back surface.

2. The electronic device as recited in claim 1, wherein the acute tilt includes an angle of 30 degrees.

3. The electronic device as recited in claim 1, wherein the acute tilt includes an angle of 10 degrees.

4. The electronic device as recited in claim 1, wherein the acute tilt includes a tolerance of ± 2 degrees.

5. The electronic device as recited in claim 1, wherein the at least one antenna module is located in proximity to a first peripheral side of the electronic device and includes a single antenna module without needing an antenna module at a second peripheral side opposite the first peripheral side.

6. The electronic device as recited in claim 1, wherein the at least one antenna module is positioned by a tilt platform that imparts the acute tilt to the at least one antenna module.

7. An electronic device, comprising:
an upper portion and a lower portion, the upper portion including a left peripheral side and a right peripheral side;
a back surface extending between the upper portion and the lower portion, the back surface being opposite a front surface;
wireless communication circuitry within the electronic device having at least one antenna module;
the at least one antenna module having a longitudinal axis along a length of the at least one antenna module and a width orthogonal to the length of the at least one antenna module; and
the at least one antenna module being disposed in the upper portion and having an acute tilt of the length relative to the back surface.

8. The electronic device as recited in claim 7, wherein the acute tilt includes an angle of 30 degrees.

9. The electronic device as recited in claim 7, wherein the acute tilt includes an angle of 10 degrees.

10. The electronic device as recited in claim 7, wherein the acute tilt includes a tolerance of ± 2 degrees.

11. The electronic device as recited in claim 7, wherein the at least one antenna module is located in proximity to the left peripheral side of the electronic device.

12. The electronic device as recited in claim 7, wherein the at least one antenna module is located in proximity to the right peripheral side of the electronic device.

13. The electronic device as recited in claim 7, wherein the at least one antenna module includes a single antenna module between the left peripheral side and the right peripheral side.

14. The electronic device as recited in claim 7, wherein the at least one antenna module is positioned by a tilt platform that imparts the acute tilt to the at least one antenna module.

15. An electronic device, comprising:
an upper portion and a lower portion, the upper portion including a left peripheral side and a right peripheral side;
a back surface extending between the upper portion and the lower portion, the back surface being opposite a display surface;
wireless communication circuitry within the electronic device;
an antenna module coupled to the wireless communication circuitry;
a tilt platform that imparts an acute tilt to antenna module;
the antenna module having a longitudinal axis along a length of the antenna module and a width orthogonal to the length of the antenna module; and
the antenna module being disposed in the upper portion and having an acute tilt of the length relative to the back surface.

16. The electronic device as recited in claim 15, wherein the acute tilt includes an angle of 30 degrees.

17. The electronic device as recited in claim 15, wherein the acute tilt includes an angle of 10 degrees.

18. The electronic device as recited in claim 15, wherein the acute tilt includes a tolerance of ± 2 degrees.

19. The electronic device as recited in claim 15, wherein the antenna module includes a single antenna module between the left peripheral side and the right peripheral side.

20. The electronic device as recited in claim 15, wherein the tilt platform includes a surface that reflects radio waves.
